(19) United States
(12) Patent Application Publication
(10) Pub. No.: US 2010/0108712 A1
(43) Pub. Date: May 6, 2010

(54) Multi-dose liquid dispensing assembly

(76) Inventor: Nick J. Manesis, San Ramon, CA (US)

Correspondence Address: STOUT, UXA, BUYAN & MULLINS LLP, 4 VENTURE, SUITE 300, IRVINE, CA, 92618, US

(21) Appl. No.: 12/655,513

(22) Filed: Dec. 30, 2009

Related U.S. Application Data
(63) Continuation of application No. 10/551,753, filed on Sep. 30, 2005, now abandoned.

(51) Int. Cl. B67D 7/00; B67D 7/76; B65D 47/18

(52) U.S. Cl. 222/1; 222/189.09; 222/422

(57) ABSTRACT

A dispensing assembly to be coupled to a resilient-walled vessel includes a tip defining an unobstructed bore positioned to be in direct communication with the vessel when coupled to the vessel. The tip includes a valve structured to allow drop-wise liquid dispensing when sufficient pressure is applied to the resilient wall of the vessel, and to prevent liquid back flow at zero as well as near zero pressure differentials across the valve. The assembly also includes at least one vent opening structured to allow air into and out of the vessel, and at least one filtration element extending across the vent opening. A cap having an antibacterial liner is also provided. The combination of the filtration element, the antibacterial liner in the cap, and the ability of the valve to prevent back flow enables the solution in the vessel to remain sterile, with no need for preservatives. Also included are methods for dispensing a preservative-free solution using a dispensing assembly of the present invention.

This application is a continuation application of application Ser. No. 10/551,753 and claims the benefit of provisional application Ser. No. 60/458,686, filed Mar. 31, 2003, the disclosure of each of these applications is incorporated in their entirety herein by reference.

### BACKGROUND OF THE INVENTION

The present invention relates to containers and dispensers of liquids, especially of sterile liquids such as medications and medicaments. More particularly, the invention relates to a dispensing tip for placement in or over an opening in a resilient-walled vessel, the tip including a valve structured to allow drop-wise dispensing from the vessel when sufficient manual pressure is applied to the resilient wall of the vessel, and to prevent back flow at zero as well as near zero pressure differentials across the valve.

Various liquid solutions, particularly ophthalmic pharmaceutical and OTC solutions such as anti-glaucoma, anti-allergy and dry eye solutions, must be kept sterile in order to prevent contamination from bacteria and other microbes. Typically, sterility is maintained by adding a preservative such as, for instance, benzalkonium chloride, methyl parabens, propyl parabens, thimerasol and, chlorbutanol, or another antibacterial agent such as a biguanide to a saline based formulation. Unfortunately, such preservatives and/or antibacterial agents often have unwanted side effects such as allergic reactions and/or irritation of the tissue, for instance conjunctival or corneal tissue, in the patients being treated by the solution. In order to avoid the problems associated with preservatives and/or antibacterial agents, some manufacturers have developed single service containers which remain sealed until use, eliminating the need for the preservatives and/or antibacterial agents. Such single service containers are considerably more expensive, on a per treatment basis, than containers capable of dispensing multiple doses.

Accordingly, numerous attempts have been made to develop dispensing systems allowing multiple-dose dispensing of preservative-free liquid solutions. Some of these attempts are described in Ranalletta et al. U.S. Pat. Nos. 5,025,957, 5,183,184, 5,255,826, and 5,320,254. Other attempts are described in Ryder et al. U.S. Pat. No. 5,154,325 and Kanner et al. U.S. Pat. No. 5,431,310. Still other attempts are described in Meierhoefer et al. U.S. Pat. No. 4,533,068 and Martinez et al. U.S. Pat. No. 5,310,094. The disclosures of each of the aforementioned patents is incorporated in its entirety herein by reference.

Each of the aforementioned Ranalletta et al. patents discloses a liquid dispensing nozzle assembly including an adapter for placement in a resilient-walled liquid container. The adapter includes a complex, elastomeric diaphragm defining a frustoconical nozzle that extends upwardly from a tubular elastomeric valve portion. The valve portion, which fits loosely around a nipple formation that extends upwardly from the adapter wall, terminates in a tapered sealing ring that normally seals against the adapter wall at its surface surrounding the nipple to prevent leakage of the stored liquid when the container is inverted. When the container is squeezed, the liquid in the container flows through a set of passageway bores formed in the adapter wall and exerts hydraulic pressure on the elastomeric diaphragm, thus compressing the valve portion and deflecting the sealing ring from the adapter wall to allow liquid to be discharged through the nozzle. The assembly also includes an air aspiration conduit for aspirating air into the container to replace the dispensed liquid, and an air filter, integrally formed with the valve, for filtering the air as it enters the container.

The liquid solution in the container of Ranalleta et al. must follow a rather tortuous and narrow flow path before it is dispensed through the nozzle. Initially, the solution flows in an axial direction through the passageway bores in the adapter wall. Next, the flow is diverted in a radial direction toward the inlet of the nozzle, where it is redirected in the axial direction by the nipple. One advantage of this tortuous flow path is that it slows the flow of the solution, possibly allowing drop-wise dispensing. A disadvantage, however, is that rather complicated manufacturing processes are required to provide the necessary flow restriction structures, thus increasing the overall cost of manufacture.

The Kanner et al. patent discloses a number of nozzle assemblies which, like the Ranalletta et al. nozzle assemblies, include flow restriction structures possibly enabling drop-wise dispensing. One embodiment without flow restriction structures is also disclosed. In this embodiment, the dispensing nozzle terminates in a conventional duckbill valve. The duckbill embodiment of Kanner et al. does not appear to be capable of drop-wise dispensing. Also, to the best of our knowledge, all commercially available duckbill valves allow at least some back flow at zero differential pressure across the valve. Accordingly, the duckbill nozzle assembly disclosed by Kanner et al. may not fully close after dispensing, thus allowing small amounts of contaminated liquid solution to reenter the bottle after use.

Ryder et al. shows a number of other nozzle assemblies having flow restriction structures. In one embodiment of particular interest, the nozzle includes a terminal valve portion comprising a generally circular prism portion having a normally closed slit which resiliently opens with the hydraulic pressure of the dispensed fluid, and then closes to prevent entry of the potentially contaminating air.

The patents to Martinez et al. and Meierhoefer both show nozzle assemblies having distally disposed duckbill valves, specifically duckbill valves manufactured by Vernay Laboratories, Inc. However, graphs found on the Vernay web page (http://www.vernay.com) show that all their stock products allow some back flow at zero as well as near zero pressure differentials. Accordingly, the nozzle assemblies of Martinez et al. and Meierhoefer may not effectively prevent contaminated liquid from reentering the container after dispensing.

Accordingly, there exists a need for dispensing systems allowing sterile, multiple-dose, drop-wise dispensing of preservative-free liquid solutions. In particular, a need exists for simple and economical multiple-dose, drop-wise dispensing assemblies which are substantially free of flow restriction structures and which allow substantially no back flow at zero as well as near zero pressure differentials.

### SUMMARY OF THE INVENTION

The present invention provides new and enhanced dispensing tips and/or dispensing assemblies for dispensing, for example, sterile, multiple-dose, drop-wise dispensing of preservative-free liquid solutions. Methods of dispensing using such dispensing tips and/or assemblies are also provided.

The dispensing assemblies of the present invention enable a user to dispense individual drops, rather than streams, of a liquid solution, by squeezing a resilient-walled vessel with a force that is comfortable for consumers, yet greater than the force required by dispensers having conventional duckbill valves. Furthermore, the dispensing assemblies are capable of drop-wise dispensing over a broad force range, without the need for flow restrictors or other obstructions. The dispensing assemblies of the present invention also include features, such as a back flow-resistant check valve, a filtration member, and an antibacterial cap liner, which reduce or eliminate contamination of the solution being dispensed, making the use of preservatives unnecessary. Moreover, the dispensing assemblies of the present invention are straightforwad in construction, and are simple and economical to manufacture.

In accordance with one aspect of the invention, dispensing tips to be coupled to a resilient-walled vessel comprise a tip defining a bore structured to communicate directly with the opening in a resilient-walled vessel when coupled to the vessel; and a valve that is structured to allow drop-wise dispensing from the vessel when the tip is coupled to the vessel and sufficient manual pressure is applied to the resilient wall of the vessel. The valve is further structured to prevent back flow at zero as well as near zero pressure differentials across the valve. Such dispensing tips also include at least one vent opening structured to allow air into and out of the vessel when the dispensing tip is coupled to the vessel. Advantageously, the present dispensing tips include at least one filtration element extending across the at least one vent opening and structured to allow gaseous fluid to pass through the vent opening while blocking liquid fluids and contaminants.

In a useful embodiment of the invention, the valve is a check valve having a cracking pressure equal to at least about 0.1 psi, preferably at least about 0.5 psi, and more preferably still, at least about 1.0 to 4.5 psi.

In a particularly useful embodiment, the tip is configured as a substantially gaussian, or bell-shaped, truncated cone, and the valve comprises a normally closed slit extending substantially perpendicularly through the distal end of the tip. The distal end of the tip is preferably substantially planar. The dimensions of the slit relative to the diameter of the tip, as well as the wall thickness, material properties of the tip and method of formation of the slit, are selected to ensure that the mutually facing edges extending along opposite sides of the slit exert sufficient force on one another to prevent microbe-sized particles from passing through the slit when the valve is closed. More preferably, these properties are selected such that the mutually facing surfaces exert sufficient force on one another to prevent particles larger than one micron in diameter from passing through the slit when the valve is closed. Even more preferably, the force is sufficient to prevent particles larger than 0.22 microns in diameter from passing through the slit when the valve is closed.

In one advantageous embodiment, the present dispensing tips include a retaining member structured to maintain the at least one filtration member in a fixed position relative to the at least one vent opening in the tip. Preferably, the retaining member includes at least one aperture alignable with the at least one vent opening, wherein the aperture and the vent opening are sized and placed to allow air flow through both the aperture and the vent opening regardless of the coaxial orientation of the retaining member.

In another advantageous embodiment, the present dispensing tips have a two-piece structure having a base portion formed of a first, relatively rigid material, and an end portion, including the valve, that is formed of a second, more flexible material. Preferably, the first material is selected from the group consisting of polyethylene, polypropylene, polystyrene, polycarbonate, acrylonitrile butadiene styrene, and mixtures thereof, and the second material is selected from the group consisting of silicone polymer, polyisoprene, plasticized polyvinyl chloride, polyurethane, ethylene-butylene copolymers, styrenics, and mixtures thereof.

In other advantageous embodiments, the dispensing tips include at least one deflector element structured to deflect liquid from the at least one vent opening. For instance, in one embodiment, the deflector element includes an apron structure extending radially outwardly from a central axis of the tip. In another embodiment, the at least one vent opening is located in a plateau formed on a base portion of the tip, and the deflector element comprises at least one channel provided adjacent the plateau for directing liquid away from the vent opening.

Another useful embodiment of the invention provides a cap for covering the dispensing tip when the assembly is not in dispensing use, and an anti-microbial liner located in the cap and effective in reducing or preventing contamination of the external surface of the tip about the slit. Advantageously, the anti-microbial liner comprises a resilient component adapted to sealingly engage the tip when the cap is positioned thereon, and an antimicrobial component. The antimicrobial component may comprise an anti-microbial coating on the resilient component, or may be dispersed throughout the resilient component. Alternatively, the liner may be eliminated and an antimicrobial component incorporated directly into the cap material or applied as a coating on the inner surface of the cap.

In accordance with another aspect of the invention, dispensing assemblies are provided comprising a tip defining a bore positioned to be in direct communication with the vessel when coupled to the vessel, the tip including a distal end, and a valve provided at the distal end of the tip. The valve, which extends substantially coaxially with the bore, is structured to allow drop-wise liquid dispensing from the vessel when sufficient manual pressure is applied to the resilient wall of the vessel and to prevent liquid back flow at zero as well as near zero pressure differentials across the valve. Vent openings, at least one filtration element, a retaining member, and a cap having an anti-microbial liner, as described above, may also be provided with the assembly.

In accordance with still another aspect of the invention, dispensing assemblies to be coupled to a resilient-walled vessel are provided and comprise a tip defining an unobstructed bore structured to communicate directly with the opening in the vessel when the assembly is coupled to the vessel. The tip includes a distal end, and a valve provided at the distal end of the tip. The valve extends substantially coaxially with the bore and comprises a planar surface defining at least one slit. A plurality of mutually facing surfaces extend along opposite sides of the at least one slit, the mutually facing surfaces being structured to exert sufficient force on one another when the valve is closed to prevent microbe-sized particles from passing through the at least one slit when the valve is closed. As in the previous aspects, vent openings, at least one filtration element, a retaining member, and a cap having an anti-microbial liner, as described above, may also be provided.

In accordance with yet another aspect of the invention a dispensing assembly to be coupled to a vessel containing a sterile liquid comprises a tip structured to dispense liquid from the vessel, a cap structured to cover the tip when the assembly is not in use, and an anti-microbial liner in the cap for preventing contamination of the tip. The anti-microbial liner is preferably in the form of a resilient component and an anti-microbial component, wherein the anti-microbial component may either be dispersed throughout the resilient component or provided in the form of a surface coating thereon.

In accordance with a further aspect of the invention, dispensing assemblies to be coupled to a vessel containing a liquid are provided and comprises a dispensing tip including a normally closed valve structured to allow dispensing from the vessel when the dispensing tip is coupled to the vessel and the valve is open, at least one vent opening structured to allow air into and out of the vessel when the dispensing tip is coupled to the vessel, at least one filtration member extending across the at least one vent opening and structured to allow gaseous fluids to pass through the vent opening while blocking liquid fluid and contaminants, and a retaining member structured to maintain the at least one filtration element in a fixed position when juxtaposed therewith. The retaining member defines at least one aperture configured to communicate with the vent opening when the retaining member is juxtaposed with the filtration member, regardless of the coaxial orientation of the retaining member.

In a useful embodiment, the at least one vent opening comprises a plurality of vent openings symmetrically arranged about the valve (or the base of the nozzle), and the at least one aperture comprises a plurality of apertures sized and placed to allow communication between the apertures and the vent openings regardless of the angular orientation of the retaining member relative the dispensing tip.

Methods of dispensing preservative-free liquid solutions are provided in accordance with an additional aspect of the present invention. In general, these methods involve using the dispensing tips and dispensing assemblies in accordance with the present invention, as described elsewhere herein. For example, such methods comprise the steps of 1) providing a liquid solution, such as a preservative-free liquid solution, in a resilient-walled vessel having a dispensing tip including a normally closed valve structured to open when sufficient pressure, for instance manual pressure, is applied to the resilient wall and to prevent back flow at zero as well as near zero pressure differentials across the valve; and 2) applying sufficient pressure to the resilient wall to cause the valve to open. Preferably, the step of applying sufficient pressure comprises manually squeezing the container long enough to dispense one or more drops, preferably, only a single drop, of the solution. Substantially immediately after the desired amount of liquid has been dispensed, the pressure on the resilient wall of the vessel is released and the valve closes.

Each and every feature described herein, and each and every combination of two or more of such features, is included within the scope of the present invention provided that the features included in such a combination are not mutually inconsistent.

Additional aspects and advantages of the present invention are set forth in the following description and claims, particularly when considered in conjunction with the accompanying drawings in which like parts bear like reference numerals.

### BRIEF DESCRIPTION OF THE DRAWINGS

FIG. 1 is a perspective view showing a dispensing assembly according to the present invention;

FIG. 2 shows elements of the dispensing assembly of FIG. 1 in exploded relationship to one another;

FIG. 3 is a sectional view taken through line 3-3 of FIG. 1;

FIG. 3A is a bottom view of FIG. 1;

FIG. 4 is a plan view of a dispensing tip according to the present invention;

FIGS. 4A and 4B are plan views of dispensing tips having alternate slit arrangements;

FIG. 4C is a longitudinal sectional view of the tip shown in FIG. 4;

FIG. 5 is a longitudinal sectional view of a dispensing tip according to an alternate embodiment of the invention;

FIG. 6 is a perspective view of the tip shown in FIG. 5;

FIG. 7 is a view, similar to FIG. 5, of a dispensing tip according to another embodiment of the invention;

FIG. 8 is a perspective view showing the elements of the tip of FIG. 7 in exploded relationship to one another;

FIG. 9 is a perspective view showing the base portion of the tip of FIG. 7;

FIG. 10 is an exploded perspective view of a dispensing tip according to still another embodiment of the invention; and

FIG. 11 is a perspective view showing a dispensing tip according to yet another embodiment of the invention.

### DETAILED DESCRIPTION OF THE DRAWINGS

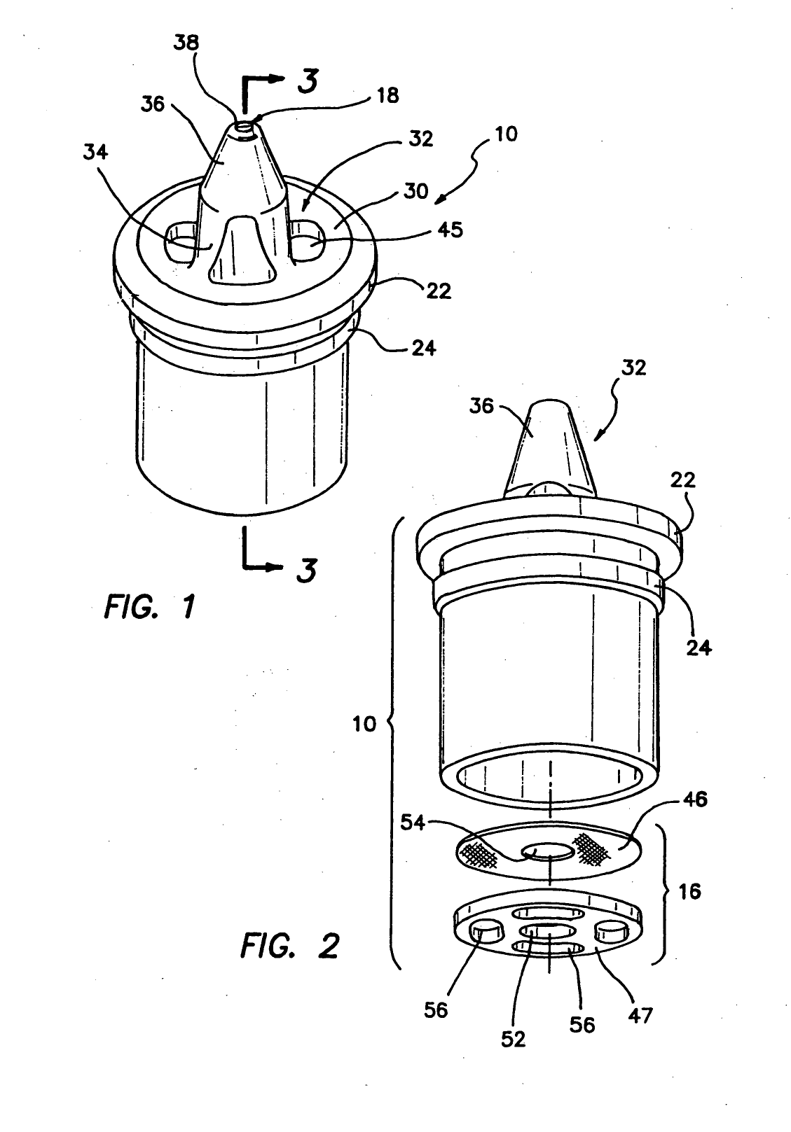

Referring now to FIGS. 1-3, a dispensing assembly or tip 10 in accordance with the present invention is provided for coupling to a resilient-walled vessel 12 such as a squeeze bottle having an open neck 14. The assembly 10 may be used to dispense liquids of virtually any kind, but is particularly useful for dispensing medicaments and other liquid pharmaceutical or ophthalmic solutions, such as anti-glaucoma, anti-allergy and dry eye solutions, that advantageously are to be kept sterile. Such solutions may be preservative-free, for example, so as to be useful to a broad range of patients, including those that are sensitive to preservatives and those that prefer no preservatives.

In conventional dispensers, such solutions would require preservatives and/or antibacterial agents. However, the combination of a microbe-impermeable filter assembly 16 and a back flow-resistant check valve 18, as described herein, make the use of preservatives and/or antibacterial agents unnecessary in solutions dispensed using the assembly 10 of the present invention.

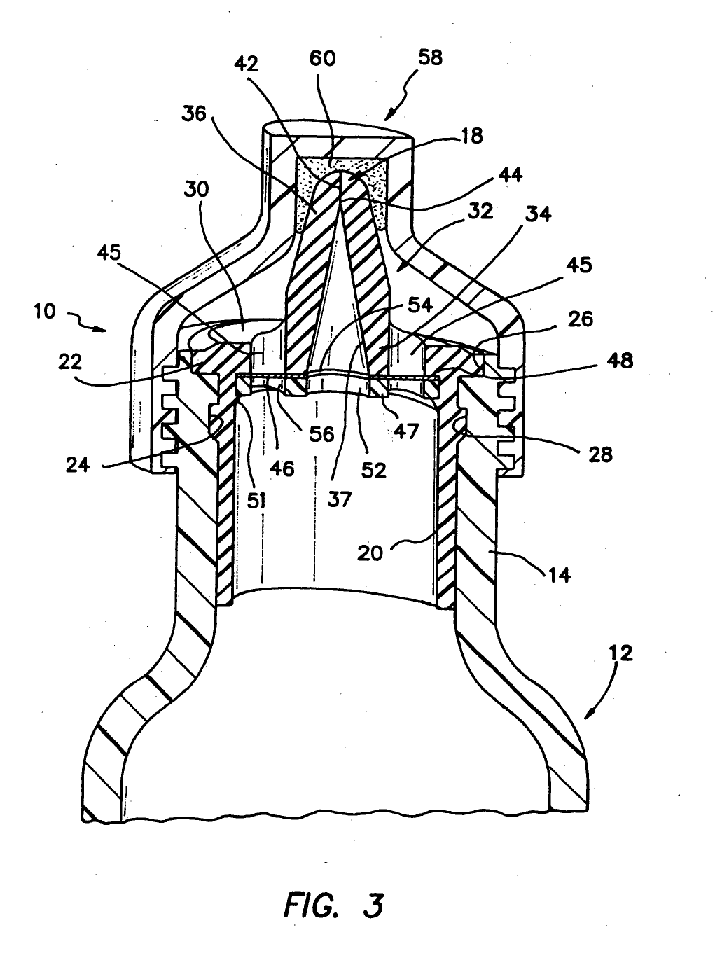

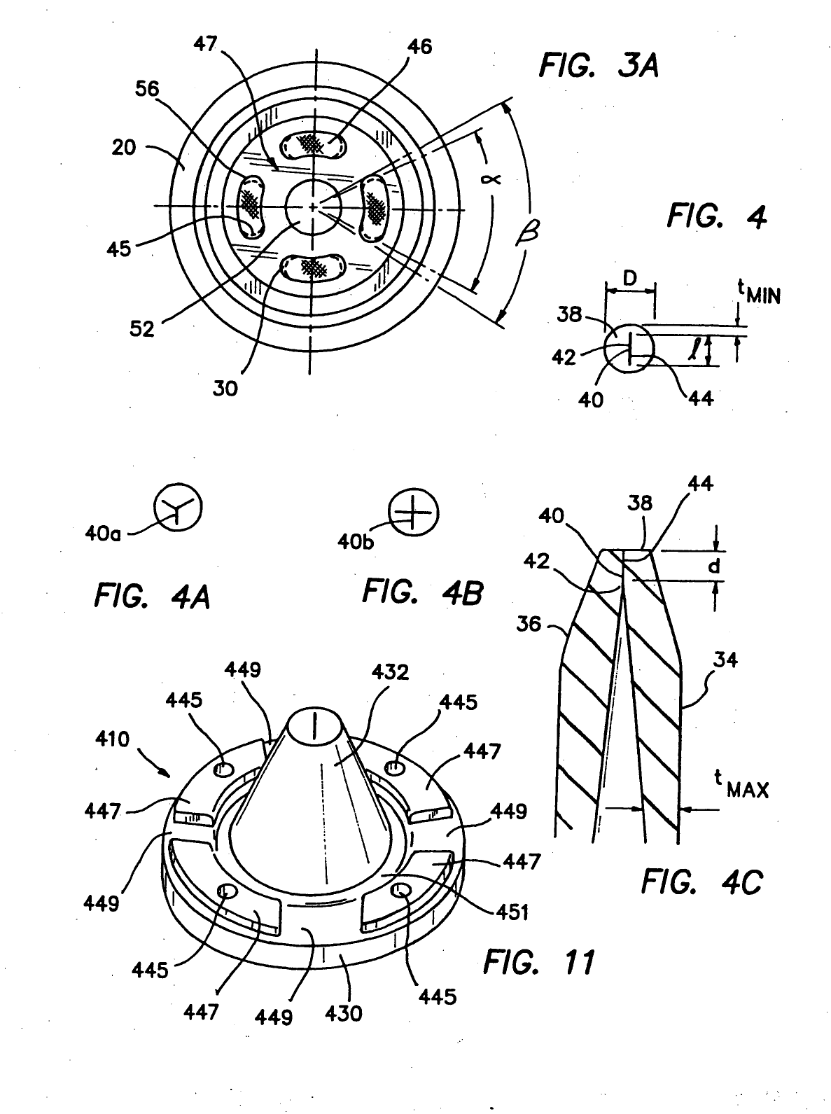

With particular reference to FIG. 3, the dispensing assembly 10 according to the present invention preferably includes a cylindrical neck 20 configured to be inserted into the open neck 14 of the vessel 12. The neck 20 of the assembly 10 preferably includes a pair of longitudinally spaced apart annular flanges or ribs 22, 24 configured to snap or otherwise fit into corresponding grooves or recesses 26, 28 in the neck 14 of the vessel 12, thus tightly securing the assembly 10 within the vessel 12 and providing a fluid-tight seal therebetween.

A base portion 30 extends transversely across a distal end of the neck 20 of the dispensing assembly, and a nozzle 32 extends distally from a central portion of the nozzle base portion 30. The nozzle 32 includes a generally cylindrical proximal portion 34 and a distal portion 36 having a substantially gaussian, or bell-shaped, truncated conical configuration. The nozzle defines a conical bore 37 communicating at its distal end with the back flow-resistant check valve 18 carried in the planar distal surface 38 of the distal portion 36 and at its proximal end with the interior of the resilient-walled vessel 12. The bore 37 may have any suitable cross-section, such as, without limitation, a circular or an oval cross section.

The back flow-resistant check valve 18, shown in greater detail in FIGS. 4 and 4C, comprises at least one normally closed slit 40 extending substantially perpendicularly through the distal surface 38. Although shown here as a single slit, plural slits such as, for instance, slits arranged in “Y” or “X” configuration could also be provided, as shown in FIGS. 4A and B, respectively. A plurality of mutually elastically contacting edges 42, 44, which may also be described as lips or mutually facing surfaces, extend along opposite sides of the slit or slits 40.

The geometry, material and method of forming of the distal portion 36 of the nozzle 32, as well as the dimensions of the slit 40 and the thickness of the material surrounding the slit 40 are selected such that the edges or surfaces 42, 44 exert sufficient force on one another when the valve is closed to prevent microbe-sized particles from passing through the at least one slit when the valve is closed. More specifically, these properties are selected such that the force exerted by the edges 42, 44 on one another when the valve is closed is sufficient to prevent particles larger than one micron in diameter from passing through the at least one slit 40 when the valve 18 is closed. Preferably, the properties are selected such that the force is sufficient to prevent particles larger than 0.22 microns in diameter from passing through the slit when the valve is closed.

The dimensions and material properties of the check valve 18 should also be selected such that the cracking pressure of the valve is greater than about 0.1 psi. More preferably, the cracking pressure of the valve should be above about 0.5 psi, and more preferably still, in the range of 1-4.5 psi, since cracking pressures in this range have been found to be comfortable for consumers, while at the same time allowing drop-wise dispensing without the need for flow restrictors in the vessel 12 or dispensing assembly 10. This is in direct contrast to conventional check valves, where manual pressure above 0.1 psi would cause liquid to exit in a stream, rather than individual drops, unless a flow restrictor or other obstruction were provided.

Both the cracking pressure and the ability of the check valve 18 to resist back flow are determined by a number of factors, including the resiliency of the elastomer in the distal end 38 of the nozzle 32, the dimensional features of the slit 40 and surrounding structure, the bulk of material surrounding the slit 40, the annular geometry of the material surrounding the slit 40 and the precision and method with which the slit 40 is formed.

Specifically, it has been found that the material used to form the distal portion 36 of the nozzle 32 should be a highly resilient material having an elongation greater than or equal to about 150% or greater than or equal to about 200%, a tear strength greater than or equal to about 150 ppi or greater than or equal to about 200 ppi, a compression set less than or equal to about 40%, and a Shore A durometer of about 30 to about 70 or about 80. Useful materials having some or all of these properties include silicone polymers, polyisoprene, plasticized polyvinyl chloride, polyurethane, ethylene-butylene copolymers, styrenics, and mixtures thereof.

Any of the above materials may optionally also include an anti-microbial agent that has been added into the resin during manufacture. Alternately, an anti-microbial agent may optionally be applied to the tip in the form of a coating. Suitable antimicrobial agents may include salts of common heavy metal oxides, including oxides of silver, gold or copper, or may be substantially metal-free. Particularly useful antimicrobial components that are known to be substantially non-leachable and to be compatible with injection-moldable resins may be selected from the group consisting of antimicrobial quaternary ammonium containing groups, antimicrobial amine-containing groups, antimicrobial peptide-containing groups, antimicrobial phosphazene-containing groups and mixtures thereof. Such antimicrobial components are more fully described in Dziabo et al. U.S. Pat. No. 5,515,117, which is incorporated in its entirety by reference herein.

Regarding the dimensional features of the slit 40, the preferred slit length l for a nozzle 32 having a length of 0.25-0.75 inches and a distal end diameter D in the range of about 0.05 to 0.21 inches is in a range of about 0.04 to about 0.2 inches. The optimum depth d for such a slit 40 is preferably in a range of about 0.01 to about 0.1 inches. The minimum wall thickness t_{MIN} (i.e. the thickness of the wall between an end of the slit 40 and the outer circumference of the distal surface 38) preferably is no less than about 0.01 inches. The maximum wall thickness t_{MAX} (i.e. the thickness of the wall between the bore 37 and the outer surface of the nozzle 32 at the junction between the cylindrical proximal portion 34 and the substantially gaussian truncated conical distal portion 36) preferably is no less than about 0.02 inches.

In relative terms, the length l of the slit 40 preferably is no greater than about 0.96 D, where D is the diameter of the planar distal surface 38 of the nozzle 32. The depth d of the slit 40 preferably is no less than about 0.04 D. The maximum wall thickness t_{MAX} preferably is no less than about 1.5 d.

In accordance with the present invention, the process of forming the slit 40 in the planar surface 38 preferably is carefully controlled in order both to obtain the proper cracking pressures and to ensure that no back flow occurs at zero as well as near zero pressure differentials.

Accordingly, a new procedure for introducing the slit into the surface in a clean, precise, and reproducible manner has been discovered. This process comprises inserting the nozzle 32 distal end down in a female cavity in a blocking fixture. The cavity has an inner geometry substantially matching, for example substantially exactly matching, the outer geometry of the nozzle 32, and includes an opening having a diameter substantially equal to, for example substantially exactly equal to, the outer diameter of the distal surface 38 of the nozzle 32. Very slight compression of the nozzle end 36 occurs when the nozzle 32 is placed in the fixture.

Once the nozzle 32 has been placed in the blocking fixture such that the axis of the nozzle is substantially perpendicular to the plane of the fixture and the distal end 38 is aligned with the matching opening, a slitting blade is positioned coaxially over the tip and actuated downwardly through the distal end of the nozzle. The slitting blade, preferably made of hardened stainless steel or ceramic, is sharpened at one end to resemble a double edged chisel, wherein the taper of the cutting edge is longer than, for example about 0.05 inches longer than, the wall thickness of the distal end 38. Thus, the blade is able to consistently penetrate the surface 38 and create a clean, complete slit having a width equal to the edge-to edge distance (i.e. the width) of the blade.

A hard rubber pad, for example having a Shore A durometer of about 70 to about 100, is placed under the surface 38 during the slitting operation to substantially prevent, minimize, or at least reduce flexing thereof. The blade moves downwardly until it encounters a mechanical stop, which ensures that exactly the desired length of slit is obtained, at which point the blade is retracted and the nozzle 32 removed from the blocking fixture.

Various other methods of forming the slit will readily occur to the skilled practitioner, and are included within the scope of the present invention.

In addition to the check valve 18, the dispensing assembly 10 includes a plurality of vent openings 45 allowing gaseous fluids such as air to flow into and out of the bottle. In the illustrated embodiment, four generally triangular openings 45 are provided at intervals of approximately 90°. The base of each triangular opening 45 extends circumferentially along the base portion 30 of the dispensing assembly 10, subtending an angle of approximately 45°. The apex of each triangular opening 45 extends axially, terminating near the proximal end of the distal end portion 36 of the nozzle. However, this arrangement of openings is merely exemplary. Various arrangements involving other shapes, sizes and numbers of vent openings 45 will also be apparent to the skilled practitioner, and are included within the scope of the present invention.

At least one filtration element 46, such as a membrane or the like, is juxtaposed with the vent openings 45 to prevent liquid and airborne contaminants from entering the vessel 12. Preferably, the filtration element 46 is in the form of an annular disk having its underside communicating with the interior of the vessel 12 and its upper surface abutting the base portion 30 of the dispensing assembly. Any commercially available hydrophobic, air permeable filter having a sufficiently small pore size to exclude bacteria may be suitable for use in this assembly. The filtration element 46 may optionally also be made from or treated with one or more antibacterial materials, such as oxides of silver, gold or copper, or any of the substantially non-metal, non-leachable antibacterial components described in the aforementioned Dziabo et al. patent.

In the illustrated embodiment, a retainer member 47 is positioned against the filtration element 46 for securing the filtration element 46 in place against the annular underside 48 of the base member 30, preventing air from moving around it. The retaining member 47 is shown here as a rigid ring secured within the cylindrical neck 20 of the dispensing assembly 10. Preferably the neck 20 includes a chamfered lip 51 that urges the retaining member or ring 47 tightly against the annular underside 48.

Alternately, the entire filtration element retainer member assembly 16 may be inserted as stated above but with the filtration element 46 on the opposite side of the retainer member 47.

Other methods of securing the filtration element to the retaining member or ring 47 may also be used. For instance, the filtration element 46 may be adhesively bonded or heat sealed to the retaining member 47, or molded with the retaining member 47 as an integral assembly. Alternatively, the retaining member could be dispensed with altogether, and the filtration element 46 could be press fit directly into the cylindrical neck 20, molded in place at the time of fabrication, or sealed against the annular underside 48 of the base member 30, for instance by heat sealing, adhesive bonding, welding or the like.

The retaining member or ring 47 includes a central bore or aperture 52 that is alignable with the central bore or aperture 54 of the filtration element, thus allowing liquid to flow unimpeded from the vessel 12 to the dispensing nozzle 32. In addition, the retaining member 47 includes a number of vent apertures 56 that are alignable with the vent openings 45 in the base portion 30 of the dispensing assembly 10. Preferably, the size and position of the vent apertures 56 is selected to allow air flow through both the vent apertures 56 and the vent openings 45 regardless of the coaxial orientation of the retaining member relative the vent apertures 56. In other words, the vent apertures 56 are configured to ensure that at least a portion of at least one of the vent apertures 56 communicates with at least a portion of at least one of the vent openings even if either the retaining member 47 or the base member 30 is unintentionally moved along or rotated about their common axis. This ensures that air flow will not be blocked if the retaining member 47 is misaligned during the assembly process.

In the illustrated embodiment, since the base portion 30 includes four vent openings 45 arranged 90° apart, each vent opening subtending an angle α, the retaining member 46 includes four vent apertures 56, each subtending an angle β>α, as seen in FIG. 3A. Alternatively, the retaining member 46 could have a single vent aperture subtending an angle greater than 270°, two vent apertures, each subtending an angle greater than 135°, and so forth. The skilled practitioner will recognize numerous variations that can be made in the number, size and spacing of the vent apertures 56 that will allow continuous air flow through the vent openings 45, even in the event of misalignment of the retaining member 47. All such variations are included within the scope of the present invention.

The dispensing assembly 10 preferably includes a protective cap 58, as shown in FIG. 3. The cap 58 preferably defines an inner cavity having a shape that generally conforms to the shape of at least the distal end 36 of the dispensing nozzle 32. An anti-microbial liner 60 in the cap prevents contamination of the nozzle 32. The liner 60 is preferably made of a resilient material such as silicone polymer, rubber, sponge, or the like. An anti-microbial agent may either be dispersed throughout or applied as a coating to the resilient material.

The protective cap 58 preferably is internally threaded, allowing it to be screwed on over external threads provided on the neck 14 of the vessel 12. However, other ways of securing the cap 58 to the vessel are also included within the scope of the invention.

In the illustrated embodiment, the liner 60 is configured to be in intimate contact with the distal end 36 of the nozzle 32 when the cap 58 in a closed position over the assembly. Alternately, the liner 60 may be configured to allow a small gap between the liner 60 and the distal end 36, thus allowing any residual liquid on the end 36 to be wicked onto the liner, while avoiding contact between the distal end 36 and the antimicrobial component.

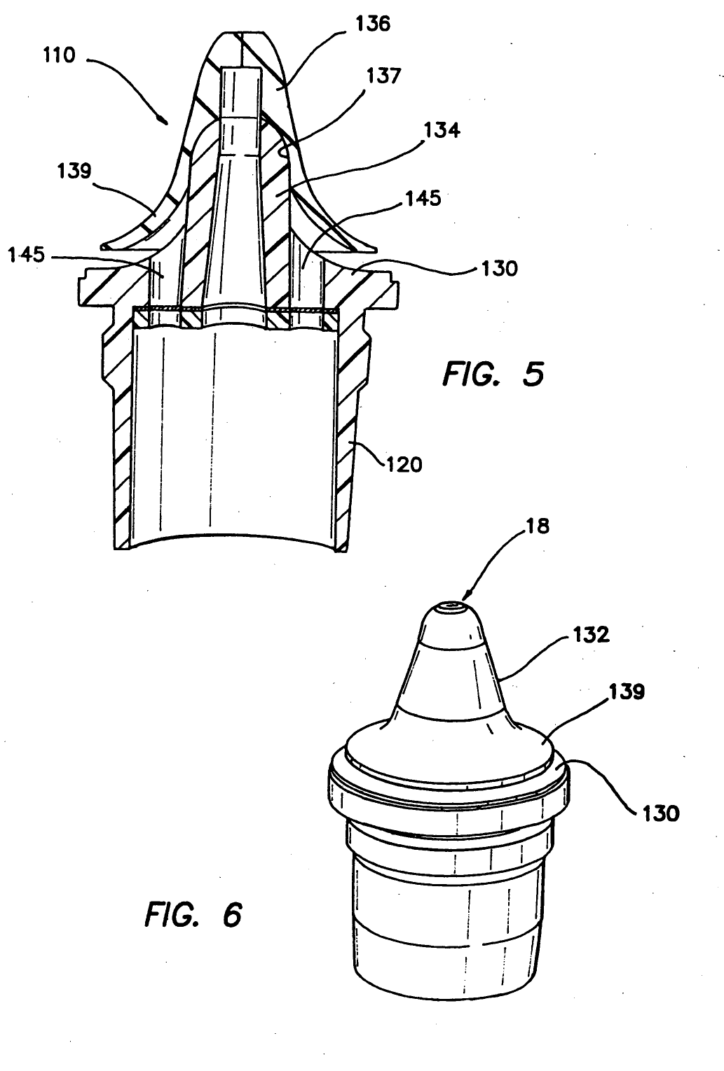

A two-piece dispensing assembly 110 illustrating the principles of the present invention is shown in FIGS. 5 and 6. The neck 120, the base 130, and the proximal portion 134 of the nozzle 132 of this assembly 110 are integrally formed, for instance molded, from a first, relatively rigid material, preferably selected from the group consisting of polyethylene, polypropylene, polystyrene, polycarbonate, and acrylonitrile-butadiene-styrene, and mixtures thereof, while the distal portion 136 of the nozzle 132 is made from a more resilient material, preferably from the group consisting of silicone polymer, polyisoprene, plasticized polyvinyl chloride, polyurethane, ethylene-butylene copolymers, styrenics, and mixtures thereof.

The distal portion 136 of the nozzle 132, which includes a normally closed check valve 18 as described above, is configured as a female element having a generally cylindrical cavity 137 for receiving the generally cylindrical proximal portion 134 of the nozzle 132. The proximal portion 134 may simply be press-fit or snapped into the cavity 137, or it may be bonded in place by means of over-molding, adhesives, heat sealing, welding, or the like.

The distal portion 136 further includes a skirt or apron portion 139 that circumscribes the cylindrical cavity 137 and slopes radially outwardly in the proximal direction to form a roof or shield over the vent openings 145 in the base 130. This prevents any residual liquid, or runoff, from flowing into and blocking the vent openings 145. The proximal end of the apron portion 139 is spaced from the base 130 and extends substantially perpendicularly to the axis of each vent opening 145, thus forming an angle in the path followed by ventilation air.

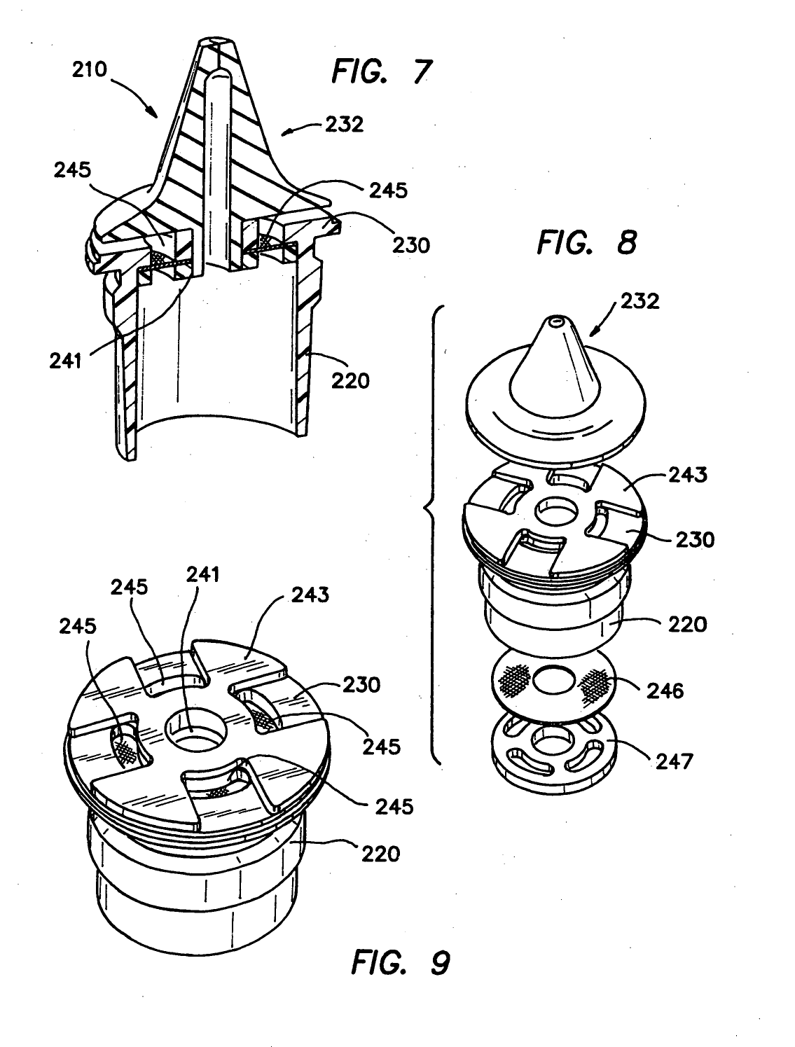

FIGS. 7-9 show a dispensing assembly 210 that is generally similar to the previous assembly 110, except that the entire nozzle 232 is formed of relatively resilient material and is configured as a male element configured to be received in a central bore 241 of the base portion 230. The base portion 230, which is formed of more rigid material, includes a raised cloverleaf structure 243 which serves as a seat for supporting the proximal surface of the nozzle 232, as well as spacing means for maintaining the nozzle 232 a sufficient distance from the vent openings 242 to ensure a substantially unimpeded flow of ventilation air.

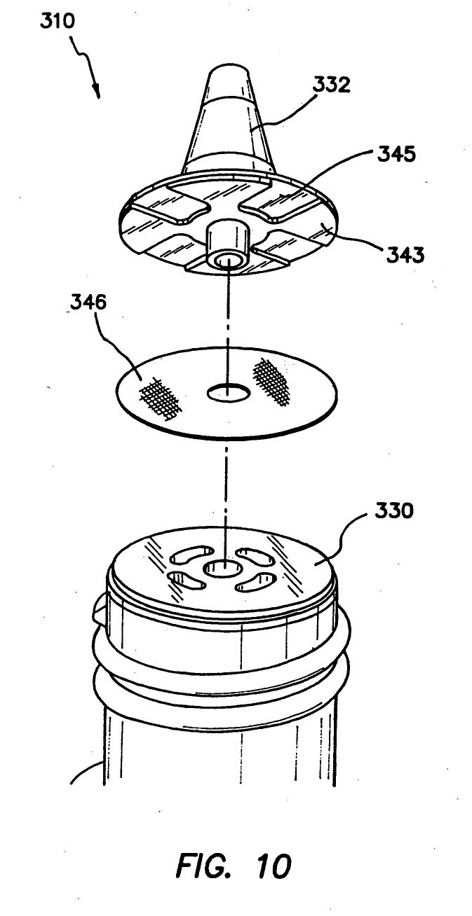

In an alternate dispensing assembly 310 shown in FIG. 10, a cloverleaf structure 343 is integrally formed on the proximal surface 345 of the nozzle 332, rather than on the base portion 330 of the assembly 310. In addition, the filtration element 346 is sandwiched between the base 330 and the proximal end 343 of the nozzle, eliminating the need for a retaining ring.

FIG. 11 shows an alternative arrangement for deflecting runoff liquid from the vent openings 445 in the base portion 430 of a dispensing assembly 410. Each of the vent openings 445 is formed in a raised plateau 447. Each plateau 447 is separated from an adjacent plateau 447 by a gutter 449 that extends radially outwardly from an internal annular gutter 451 surrounding the nozzle 432. Other arrangements for deflecting runoff liquid will be apparent to the skilled practitioner. For instance, an annular wall or chimney could be provided around each vent opening 445. All such arrangements are included within the scope of the present invention.

A method of dispensing a preservative-free solution using a dispensing assembly of the present invention comprises the steps of: providing the preservative-free solution in a resilient-walled vessel having a tip defining an unobstructed bore directly communicating with the vessel and a check valve provided at the distal end of the tip, the valve being structured to allow drop-wise liquid dispensing from the vessel when sufficient manual pressure is applied to the resilient wall of the vessel, and to prevent liquid backflow at zero as well as near zero pressure differentials across the valve; applying sufficient manual pressure to the resilient wall of the vessel to dispense a single drop of the solution; and immediately removing the manual pressure to close the valve and prevent further dispensing and/or backflow. Preferably, the amount of manual pressure applied is greater than about 0.1 psi, and more preferably is greater than about 0.5 psi. Most preferably, the amount of manual pressure applied is in the range of about 1 to about 4.5 psi.

While this invention has been described with respect to various specific examples and embodiments, it is to be understood that the invention is not limited thereto and that it can be variously practiced within the scope of the following claims.

What is claimed is:

1. A method of dispensing a preservative-free solution comprising the steps of:
providing the preservative-free solution in a resilient-walled vessel having a tip defining an unobstructed bore directly communicating with the vessel and a valve provided at the distal end of the tip, the valve being structured to allow drop-wise liquid dispensing from the vessel when sufficient manual pressure is applied to the resilient wall of the vessel, and to prevent liquid backflow at zero as well as near zero pressure differentials across the valve;
applying sufficient manual pressure to the resilient wall of the vessel to dispense a single drop of the solution; and
immediately thereafter removing the manual pressure to close the valve.

2. A method of dispensing a preservative-free solution comprising the steps of:
providing the preservative-free solution in a resilient-walled vessel having a tip defining a bore in direct communication with the vessel, the tip including a distal end, and a valve provided at the distal end of the tip, the valve extending substantially coaxially with the bore, wherein the valve is structured to allow drop-wise liquid dispensing from the vessel when the assembly is coupled to the vessel and sufficient manual pressure is applied to the resilient wall of the vessel, and to prevent liquid back flow at zero as well as near zero pressure differentials across the valve;
applying sufficient manual pressure to the resilient wall of the vessel to dispense a single drop of the solution; and
immediately thereafter removing the manual pressure to close the valve.

3. A dispensing assembly to be coupled to a resilient-walled vessel containing a liquid, comprising:
a neck portion including a sidewall structured to engage an interior wall of a resilient walled-vessel containing a liquid;
a tip distally extending from the neck portion, including a distal end and defining a bore positioned to be in direct communication with an interior of a resilient-walled vessel containing a liquid when coupled to said resilient-walled vessel to provide a linear fluid flow path from said interior of said resilient-walled vessel to the distal end of the tip; and
a valve provided at the distal end of the tip, the valve extending substantially coaxially with the bore;
wherein the valve is structured to allow drop-wise liquid dispensing from said resilient-walled vessel when the assembly is coupled to said resilient-walled vessel and sufficient manual pressure is applied to said resilient-walled vessel, and to prevent liquid back flow at zero pressure differential and near zero pressure differentials across the valve.

4. The dispensing assembly of claim 3, further comprising:
at least one vent opening structured to allow air into and out of the vessel when the dispensing assembly is coupled to the vessel; and
at least one filtration element extending across the at least one vent opening and structured to allow gaseous fluids to pass through the vent opening while blocking liquid fluids and contaminants.

5. The dispensing assembly of claim 4, wherein the at least one vent opening is oriented at a substantially perpendicular angle to the bore of the tip.

6. The dispensing assembly of claim 4, wherein the at least one vent opening is oriented coaxially with the bore of the tip.

7. The dispensing assembly of claim 4, further comprising a retaining member structured and positioned to maintain the at least one filtration element in a fixed position.

8. The dispensing assembly of claim 3 (106, wherein the valve comprises a distal surface, at least one slit extending through the distal surface and a plurality of mutually facing surfaces extending along opposing sides of the at least one slit, the plurality of mutually facing surfaces being structured to exert sufficient force on one another when the valve is closed to prevent microbe-sized particles from passing through the at least one slit when the valve is closed.

9. The dispensing assembly of claim 8, wherein the plurality of mutually facing surfaces are structured to exert sufficient force on one another to prevent particles larger than 0.22 microns in diameter from passing through the at least one slit when the valve is closed.

10. The dispensing assembly of claim 3, further comprising a cap structured to cover the tip when the assembly is not in dispensing use.

11. The dispensing assembly of claim 10, further comprising an anti-microbial liner in the cap.

12. The dispensing assembly of claim 3, wherein the tip is an over-molded elastomeric nozzle coupled to the neck portion, and the assembly further comprises at least one vent opening located in the neck portion structured to allow air into and out of the vessel when the dispensing tip is coupled to the vessel, and at least one co-molded filtration member extending across the at least one vent opening and structured to allow gaseous fluids to pass through the vent opening while blocking liquid fluid and contaminants.

13. The dispensing assembly of claim 3, wherein the neck portion is formed of a first material, and the tip is formed of a second material more flexible than the first material.

14. The dispensing assembly of claim 13, wherein the first material is selected from the group consisting of polyethylene, polypropylene, polystyrene, polycarbonate, and acrylonitrile-butadiene-styrene polymers, and mixtures thereof, and the second material is selected from the group consisting of silicone, polyisoprene, plasticized polyvinyl chloride, polyurethane, ethylene-butylene copolymers, and mixtures thereof.

15. The dispensing assembly of claim 3, further comprising a filtration member, wherein the neck portion, the tip, and the filtration member are coupled together as a unitary structure to be coupled to resilient walled vessel.

16. The dispensing assembly of claim 3, wherein the bore of the tip-provides an unobstructed fluid flow path from the vessel to the tip.

17. The dispensing assembly of claim 3, wherein the valve is a check valve having a cracking pressure greater than 0.1 psi.

18. The dispensing assembly of claim 3, wherein the distal end of the tip has a diameter, and the valve comprises a slit formed in the distal end, the slit having a length less than the diameter of the distal end of the tip.

19. The dispensing assembly of claim 3, further comprising at least one deflector element structured to deflect liquid away from the at least one vent opening.

20. The dispensing assembly of claim 3 coupled to a resilient-walled vessel containing a liquid.
